(19) United States
(12) Patent Application Publication
(10) Pub. No.: US 2024/0086446 A1
(43) Pub. Date: Mar. 14, 2024

(54) SYSTEMS AND METHODS FOR IDENTIFYING A RISK OF PARTLY OVERRULED CONTENT BASED ON CITATIONALLY RELATED CONTENT

(71) Applicant: Thomson Reuters Enterprise Centre GmbH, Zug (CH)

(72) Inventors: Gayle McElvain, Arlington, VA (US); Dhivya Infant Chinnappa, Eagan, MN (US); Travis Jon Denneson, Rosemount, MN (US); Diane Lynne Erickson, Woodbury, MN (US)

(21) Appl. No.: 18/466,746

(22) Filed: Sep. 13, 2023

Related U.S. Application Data
(60) Provisional application No. 63/405,915, filed on Sep. 13, 2022.

(51) Int. Cl. G06F 16/35; G06F 40/194; G06F 40/279; G06Q 50/18

(52) U.S. Cl. CPC G06F 16/35; G06F 40/194; G06F 40/279; G06Q 50/18

(57) ABSTRACT

Aspects of the present disclosure provide systems, methods, apparatus, and computer-readable storage media that support identifying overruled in part content based on citationally related content. The most relevant passage, content, paragraph and the like, may be identified out of the citationally related content by providing extracted features as input data to trained machine learning classifiers to generate probability values. A ranking approach may be used where the content or paragraphs of an opinion may be selected as most relevant based on the generated probability values. In some implementations, a machine learning modeling approach may be used for both the overruling side and the overruled side of the content by leveraging different features and the relationship between the overruling document and the overruled document.

### CROSS-REFERENCE TO RELATED APPLICATIONS

The present application claims the benefit of priority from U.S. Provisional Patent Application No. 63/405,915, filed Sep. 13, 2022, and entitled “SYSTEMS AND METHODS FOR IDENTIFYING A RISK OF PARTLY OVERRULED CONTENT BASED ON CITATIONALLY RELATED CONTENT,” the disclosure of which is incorporated by reference herein in its entirety.

### TECHNICAL FIELD

The present disclosure relates generally to electronic devices and tools that perform data identification. More particularly, aspects of the present disclosure relate to identifying a risk of content partly, but not entirely, affected by treatment of other content.

### BACKGROUND

Many documents rely on the content of other documents when making assertions or providing conclusions. For example, a first legal case may be partly overruled by a second legal case with respect to a legal issue discussed in the first legal case. In this situation, the first legal case may be affected, as it contains at least one legal issue that has been overruled and other legal issues that are not overruled (i.e., the first legal case contains analysis of some legal issues that remain valid, but is invalid with respect to the overruled legal issue). Because the first legal case is not entirely overruled by the second case, it may be difficult to detect the particular legal issue(s) that has been overruled by the overruling case (i.e., the second legal case in this example). In this situation, a lawyer may either avoid citing or relying on the first legal case in its entirety or spend substantial time manually reviewing the first and second legal cases to determine whether the legal issue or point of law for which the lawyer wants to cite the first case is not the legal issue that has been overruled in part by the overruling case.

Current citation systems lack functionality to address the above situation. Although current systems may be able to identify explicitly overruled legal cases and flag them, when only a portion of a legal case has been overruled, or when a legal case includes a legal issue that has received negative treatment in another legal case without explicitly overruling the entire case, current systems are not able to identify and/or flag the relevant portions of the partly overruled legal cases. This leaves manual review of an entire legal case history as the only option to identify whether a portion of a case is still valid law. Such manual review is inaccurate, time consuming, and may omit important portions of a ruling that are still valid law. Additionally, automated systems can perform natural language processing (NLP) to search for particular terms, but these automated systems lack sufficient accuracy to be relied upon by lawyers or legal researchers. Thus, there remains a need for an electronic tool that can quickly and automatically identify a relevant portion of a legal case that has been overruled in part with sufficient accuracy.

### SUMMARY

Aspects of the present disclosure provide systems, methods, apparatus, and computer-readable storage media that support identifying overruled in part content based on citationally related content to address these deficiencies. In aspects, case law data may be received from one or more data sources by a legal research tool (e.g., an electronic tool), and the case law data may be associated with a first case law document (i.e., a case that may be said to be “overruled in part”, also referred to as an overruled document or case) and with a second case law document (i.e., a case that may be said to be “overrule in part” the first case, also referred to as an overruling document or case) that overrules at least a portion of the first case law document. Because the second case law document overrules at least a portion, but not an entirety, of the first case law document, the first case law document may be said to be “overruled in part” and may be referred to as the overruled document, and the second case law document may be referred to as the overruling document. Features may be extracted by the legal research tool from the case law documents, and the extracted features may be input to one or more trained machine learning (ML) classifiers. In some implementations, the features extracted from the overruling document may include heuristics-based features and statistics-based features, and the features extracted from the overruled document may include heuristics-based features. The heuristics-based features may have been identified during an analysis and ML architecting process as being particularly relevant to identifying portions of overruling documents or portions of overruled documents that indicate the overruled in part legal holdings. A first set of ML classifiers may output probability values that indicate probabilities that each of multiple content portions of the overruling document are the most relevant overruling portion, and the content portions may be ranked based on the probability values to select a highest ranked portion as an overruling passage. In some implementations, the first set of ML classifiers includes a feed forward neural network (FNN) classifier and an extreme gradient boosting (XGBoost) classifier. The overruling passage may be a sentence, paragraph, or other portion of the legal opinion or footnotes that is automatically identified as the passage that overrules in part the overruled document. For example, the overruling passage may overrule, or negatively treat, a point of law from the overruled document without overruling other points of law in the overruled document, such that the other points of law may still be relied on. The legal research tool may output the overruling passage, such as by displaying the overruling passage in a graphical user interface (GUI), to enable a user (e.g., a legal researcher or lawyer) to identify the most relevant portion of the overruling document that is citationally related to the overruled document, without requiring manual review of the entire overruling document, and with greater accuracy than automated systems that merely perform keyword searches. Thus, the legal research tool herein provides the user with automatically identified document portions that have greater utility than simply providing the entire document, and that are more accurately identified than other computerized techniques, for identifying overruled in part citational relationships. It is noted that, as used herein, a citational relationship may refer to the relationship between two documents and may include at least one of: a first document being cited by a second document, the first document citing the second document, and the first and second document relying on or treating the same point of law. In either of these cases, the first and the second documents may be said to be citationally related. In some cases, the first and second documents may rely on or treat the same point of law without one case explicitly citing or mentioning the other case.

In some implementations, in addition to identifying and outputting the overruling passage, the legal research tool described herein may identify a passage of the overruled document that is most relevant to the point of law being overruled by the overruling document, and the overruling passage. In aspects, the legal research tool may extract a set of features from a subset of the highest ranked portions of the overruling document, and the set of features may be input to a second ML classifier (e.g., a linear classifier) to identify a most relevant headnote of the overruled case that is related to the overruled point of law. As used herein, a headnote may refer to a brief summary of a legal rule or significant facts of a legal case, and such headnotes may be included in published legal opinions, generated by a legal research service provider, or both. The legal research tool may extract features from the selected headnote and from the overruled document for use as input to a third ML classifier that outputs probability values that indicate probabilities that each of multiple content portions of the overruled document are the most relevant overruled portion. In some implementations, the third ML classifier includes a FNN classifier. Similar to the overruling document, the content portions of the overruled document may be ranked based on the probability values to select a highest ranked portion as an overruled passage. For example, the overruled passage may explain the holding or the point of law from the overruled document that is being overruled in part by the overruling document. The legal research tool may output the overruled passage, such as by automatically scrolling to the overruled passage in the GUI. This may enable the user to identify the most relevant portion of the overruled document that is being overruled without requiring manual review of the entire overruled document, and with greater accuracy than automated systems that merely perform keyword searches. As a non-limiting example, the legal research tool may display a graphical indicator, such as a striped red flag, to indicate that a particular legal document has been overruled in part, as compared to a legal document that is entirely overruled and which is indicated by a solid red flag. Selection of the graphical indicator may cause the GUI to automatically scroll the overruled document to the overruled passage, which may be visually indicated, and selection of another visual indicator may cause display (e.g., in a pop-up window or the like) of the overruling passage from the overruling document. As such, the legal research tool described herein may enable efficient and quick identification of highly relevant portions of citationally related documents without requiring manual review of the entirety of the documents, and with increased accuracy as compared to other legal research systems. Thus, the legal research tool may enable a user to rely upon information from documents that are overruled in part, as compared to legacy research systems that only indicated whether a legal document was clean or overruled, without providing finer granularity of overruling content.

It is also noted that, although the discussion that follow is directed to embodiments in the legal field involving legal cases, it will be appreciated that aspects disclosed herein are applicable to any situation in which documents, content, and/or any type of data may be related to each other, such as by a citational relationship or a validity relationship (e.g., a first document may be deemed valid based on the validity of a second document), such as with documents, articles, books, legislation, court opinions, patents, legal filings, etc. As such, the discussion herein with respect to legal cases and court opinions is for illustrative purposes and should not be construed as limiting in any way.

In one particular aspect, a method is provided for identifying overruled in part content. The method includes receiving case law data from a first case law document from a data source. The method also includes receiving case law data from a citationally-related case law document from the data source. The citationally-related case law document overrules at least a portion of the first case law document. The method also includes ranking content of the citationally-related case law document and determining an overruled in part passage of the citationally related case law document based on the ranking. The method may also include displaying the determined overruled in part passage for a user.

In another particular aspect, a method for identifying overruled in part content based on citationally related content includes receiving, by one or more processors, first case law data from a data source. The first case law data is associated with a first case law document. The method also includes receiving, by the one or more processors, second case law data from the data source. The second case law data is associated with a citationally-related case law document that overrules at least a portion of the first case law document. The method includes providing, by the one or more processors, a plurality of features extracted from multiple content portions of the citationally-related case law document as input data to a first set of trained machine learning (ML) classifiers to generate probability values associated with the multiple content portions of the citationally-related case law document. The method also includes ranking, by the one or more processors, the multiple content portions of the citationally-related case law document based on the associated probability values. The method includes selecting, by the one or more processors, a highest ranked content portion of the multiple content portions of the citationally-related case law document as an overruling passage of the citationally-related case law document. The method further includes displaying, by the one or more processors, the overruling passage via a graphical user interface (GUI) based on user selection of the first case law document with respect to the GUI.

In another particular aspect, a system for identifying overruled in part content based on citationally related content includes a memory and one or more processors communicatively coupled to the memory. The one or more processors are configured to receive first case law data from a data source. The first case law data is associated with a first case law document. The one or more processors are also configured to receive second case law data from the data source. The second case law data is associated with a citationally-related case law document that overrules at least a portion of the first case law document. The one or more processors are configured to provide a plurality of features extracted from multiple content portions of the citationally-related case law document as input data to a first set of trained ML classifiers to generate probability values associated with the multiple content portions of the citationally-related case law document. The one or more processors are also configured to rank the multiple content portions of the citationally-related case law document based on the associated probability values. The one or more processors are configured to select a highest ranked content portion of the multiple content portions of the citationally-related case law document as an overruling passage of the citationally-related case law document. The one or more processors are further configured to display the overruling passage via a GUI based on user selection of the first case law document with respect to the GUI.

In another particular aspect, a non-transitory computer-readable storage device includes instructions that, when executed by one or more processors, cause the one or more processors to perform operations for identifying overruled in part content based on citationally related content. The operations include receiving first case law data from a data source. The first case law data is associated with a first case law document. The operations also include receiving second case law data from the data source. The second case law data is associated with a citationally-related case law document that overrules at least a portion of the first case law document. The operations include providing a plurality of features extracted from multiple content portions of the citationally-related case law document as input data to a first set of trained ML classifiers to generate probability values associated with the multiple content portions of the citationally-related case law document. The operations also include ranking the multiple content portions of the citationally-related case law document based on the associated probability values. The operations include selecting a highest ranked content portion of the multiple content portions of the citationally-related case law document as an overruling passage of the citationally-related case law document. The operations further include displaying the overruling passage via a GUI based on user selection of the first case law document with respect to the GUI.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports identifying overruled in part content based on citationally related content according to one or more aspects;

FIG. 2 is a block diagram illustrating examples of prediction models for identifying overruled in part content based on citationally related content according to one or more aspects;

FIGS. 3A-C illustrate examples of a graphical user interface (GUI) of a legal research tool that is configured to identify overruled in part content based on citationally related content according to one or more aspects; and

FIG. 4 is a flow diagram illustrating an example of a method for identifying overruled in part content based on citationally related content according to one or more aspects.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Various features and advantageous details are explained more fully with reference to the non-limiting aspects that are illustrated in the accompanying drawings and detailed in the following description. Descriptions of well-known starting materials, processing techniques, components, and equipment are omitted so as not to unnecessarily obscure the aspects of the disclosure in detail. It should be understood, however, that the detailed description and the specific examples, while indicating various implementations, are given by way of illustration only, and not by way of limitation. Various substitutions, modifications, additions, and/or rearrangements within the scope of the disclosure will become apparent to those skilled in the art from this disclosure.

Systems and methods are provided herein for identifying overruled in part content based on citationally related content. In some configurations, the most relevant passage, content, paragraph and the like, may be identified out of the citationally related content. A ranking approach may be used where the content or paragraphs of an opinion may be based on a chosen set of features. A machine learning modeling approach may be used for both the overruling side and the overruled side of the content.

In some configurations, the overruling case may be considered with a ranking problem, where all paragraphs or portions in the opinion segments are ranked. The model may follow a point-wise ranking approach, where a classification model may be constructed for predicting if each paragraph from the opinion segment is relevant or not. The paragraphs may be ranked based on the prediction probabilities from the classifier, and the first ranked paragraph may be considered as the relevant paragraph. The overruled side may follow similarly, where all paragraphs in the opinion are ranked, and the first ranked paragraph may be chosen as the relevant paragraph.

Since the legal standing or authority of a legal case can change over time, legal researchers must continually verify whether the cases they cite are still valid. A legal research system or tool may assist researchers in determine whether a particular case is good law by showing all the citing references (e.g., cases which cite the particular case) and the disposition of the citing cases. If the particular case has received any negative treatment from citing cases, some legal research tools provide a visual indication next to the tile of the particular case when viewed in search results or displayed for reading by a user, and the visual indicator indicates that the particular case is negatively treated. Although the visual indicator of negative treatment is typically interpreted as an indication that the particular case has been overruled, but this is not always true. Instead, the visual indication (such as a red flag) means at least one point of law in the particular case is no longer valid or good law. However, many cases contain more than one point of law, so many cases with indicated as overruled or negatively treated are still citable for one or more non-overruled points of law. Such cases may be referred to as “partially overruled” or “overruled in part”. Unfortunately, in order to determine a case is only partially overruled, the user may need to read all the negative citing references in full, which can be prohibitively time consuming because many cases are quite long. Unlike the above-described legal research tools, legal research tools and techniques described herein are able to identify legal cases that are merely “overruled in-part”, which receive a new visual indication (e.g., a red-striped flag) to indicate the distinction with overruled cases. Additionally, the legal research tools, systems, and methods described herein enable jumping directly to the relevant overruled language within the cited case, in addition to easily navigating back and forth from overruling language in the citing case to the overruled point of law in the cited case. This enables researchers to quickly assess whether the overruling provided by the citing case matters for their reliance on the cited case in an argument.

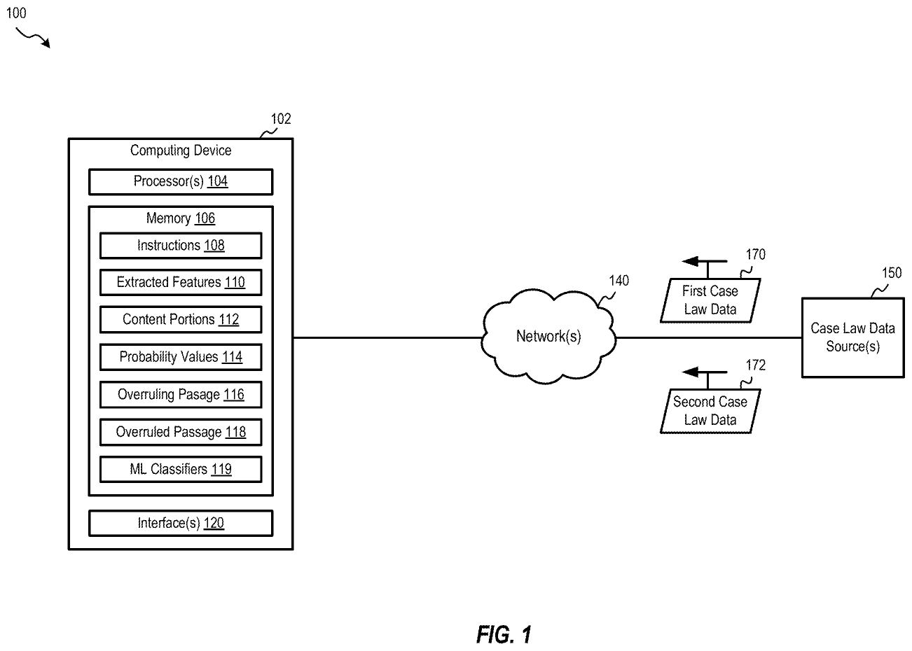

Referring to FIG. 1, an example of a system that supports identifying overruled in part content based on citationally related content according to one or more aspects is shown as system 100. As shown in FIG. 1, the system 100 may include a computing device 102, one or more case law data sources (referred to herein collectively as “case law data sources 150”), and one or more networks 140. In some implementations, the system 100 may include more or fewer components than are shown in FIG. 1, such as additional computing devices, client devices, or the like, one or more servers or cloud service components, or additional case law document sources, or the case law data sources 150 and the computing device 102 may be combined into a single device, as non-limiting examples. These elements, and their individual components, may cooperatively operate to provide functionality in accordance with the discussion herein.

The computing device 102 may be configured to perform one or more operations described herein to support identification of overruled in part content. In some aspects, the computing device 102 may include or correspond to a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other wired or wireless computing devices, or a combination thereof, as non-limiting examples. In the implementation shown in FIG. 1, the computing device 102 includes one or more processors 104, a memory 106, and one or more communication interfaces 120.

It is noted that functionalities described with reference to the computing device 102 are provided for purposes of illustration, rather than by way of limitation and that the exemplary functionalities described herein may be provided via other types of computing resource deployments. For example, in some implementations, computing resources and functionality described in connection with the computing device 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the computing device 102 may be performed by one or more servers or a cloud-based system that communicates with one or more client or user devices.

The one or more processors 104 may include one or more microcontrollers, application specific integrated circuits (ASICs), application-specific standard products (ASSPs), field programmable gate arrays (FPGAs), central processing units (CPUs) and/or graphics processing units (GPUs) having one or more processing cores, or other circuitry and logic configured to facilitate the operations of the computing device 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state, network memory, cloud memory, local memory, or a combination thereof. Software and/or firmware configured to facilitate operations and functionality of the computing device 102 may be stored in the memory 106 as instructions 108 that, when executed by the one or more processors 104, cause the one or more processors 104 to perform the operations described herein with respect to the computing device 102, as described in more detail below. Additionally, the memory 106 may be configured to store extracted features 110, content portions 112, probability values 114, an overruling passage 116, an overruled passage 118, and a first set of one or more machine learning (ML) classifiers (referred to herein as a “ML classifiers 119”). The ML classifiers 119 may include or be implemented as one or more neural networks (NNs) or one or more support vector machines (SVMs). In some other implementations, the ML classifiers 119 may include or be implemented as other types of ML or artificial intelligence (AI) models or logic, as further described herein. Illustrative aspects of the extracted features 110, the content portions 112, the probability values 114, the overruling passage 116, the overruled passage 118, and the ML classifiers 119 are described in more detail below. Although shown as being stored in memory 106, in some other implementations, the system 100 may include one or more databases integrated in or communicatively coupled to the computing device 102 (e.g., communicatively coupled to the one or more processors 104) that are configured to store any of the extracted features 110, the content portions 112, the probability values 114, the overruling passage 116, the overruled passage 118, the ML classifiers 119, or a combination thereof.

The one or more communication interfaces 120 may be configured to communicatively couple the computing device 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). The one or more networks 140 may include one or more of a wired network, a wireless communication network, a cellular network, a cable transmission system, a local area network (LAN), a wireless LAN (WLAN), a metropolitan area network (MAN), a wide area network (WAN), the Internet, the Public Switched Telephone Network (PSTN), or another network, as illustrative examples. In some implementations, the computing device 102 includes one or more input/output (I/O) devices (not shown in FIG. 1) that include one or more display devices, a keyboard, a stylus, one or more touchscreens, a mouse, a trackpad, a microphone, a camera, one or more speakers, haptic feedback devices, or other types of devices that enable a user to receive information from or provide information to the computing device 102. In some implementations, the computing device 102 is coupled to a display device, such as a monitor, a display (e.g., a liquid crystal display (LCD) or the like), a touch screen, a projector, a VR display, an AR display, an XR display, or the like. In some other implementations, the display device is included in or integrated in the computing device 102. Alternatively, the computing device 102 may be configured to provide information to support display at one or more other devices, such as a user device, a client device, or a mobile device, as non-limiting examples.

As briefly described above, the computing device 102 may be communicatively coupled to one or more other devices or systems via the one or more networks 140, such as the case law data sources 150. The case law data sources 150 may include one or more devices or components that are configured to store, and to provide access to, case law-related data. For example, the case law data sources 150 may include one or more databases, one or more computing devices, one or more servers, one or more storage devices, one or more cloud storage resources, or the like, that are configured to store the case law-related data. Case law-related data may include any data that includes information related to cases, and may include tables containing case law documents, published legal opinions, procedural documents and motions, editorial analysis, key numbers, legal blogs, court opinion reporting systems, third party case law sources, etc. In some implementations, editorial analysis may include headnotes. Headnotes may refer to editorially created summaries of the law addressed in court opinions. Key numbers may include key numbers of a research taxonomy. For example, the Westlaw Key Number System is a legal taxonomy with over 120,000 fine-grained categories. In aspects, headnotes may be assigned a key number assigning a point of law to one or more categories.

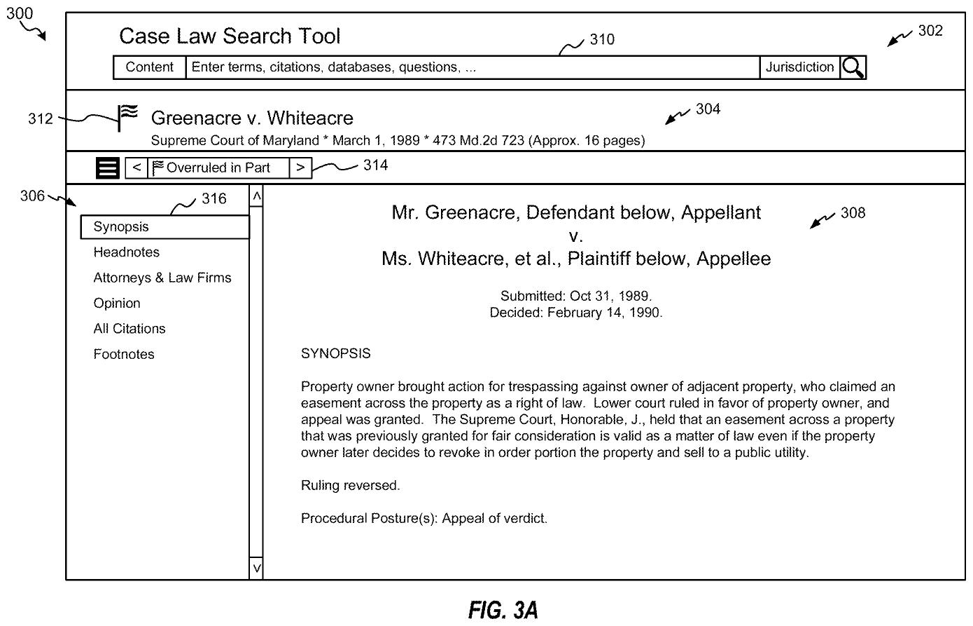

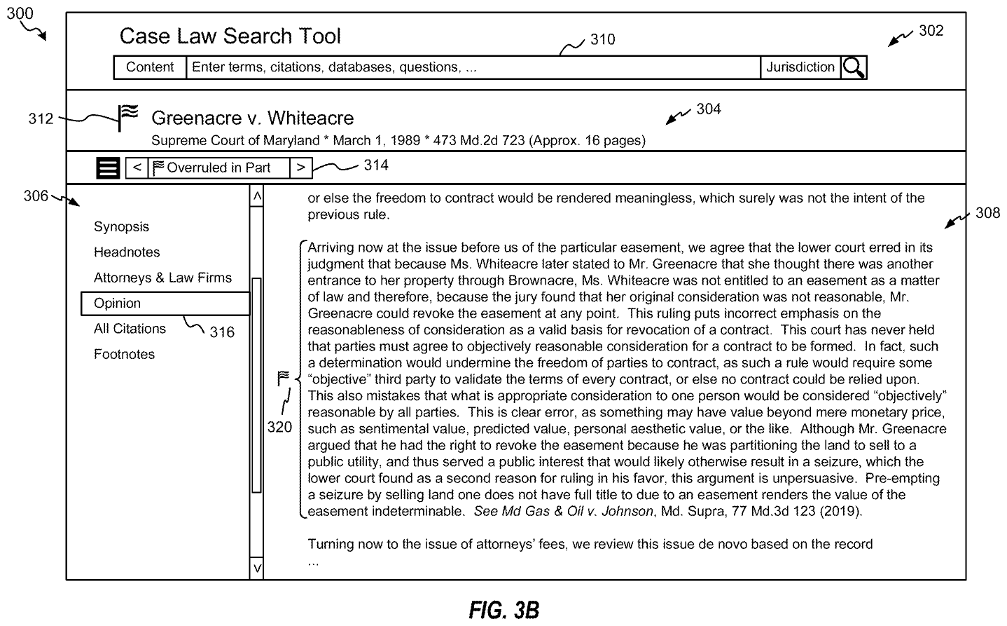

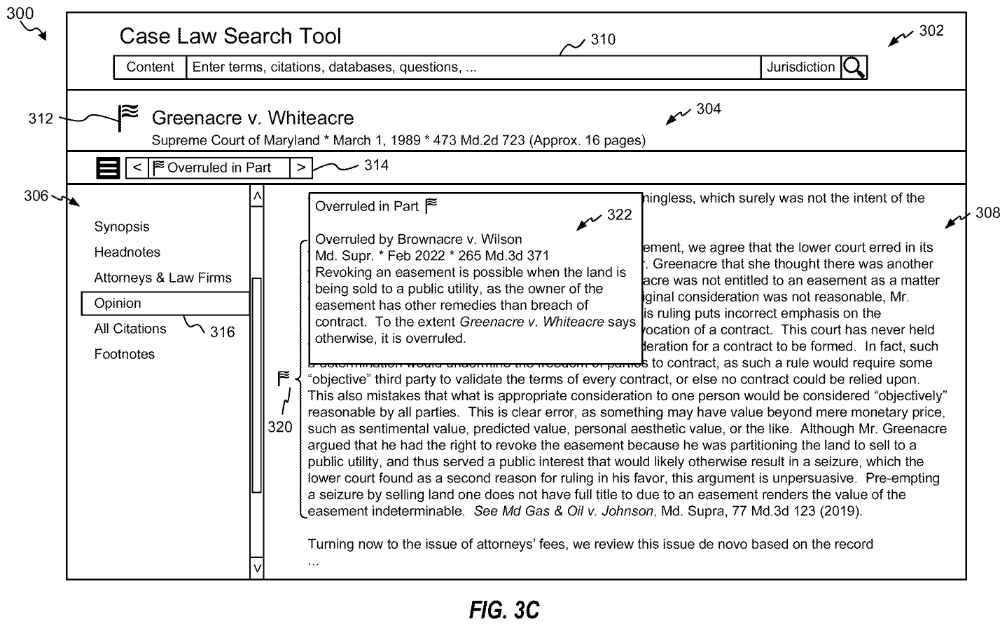

During operation of the system 100, a user of the computing device 102 may access a legal research tool executed by the computing device 102. The legal research tool may enable the user to search for various legal documents from one or more databases, and retrieved documents may be displayed via a graphical user interface (GUI). Examples of such a GUI are illustrated and described with reference to FIGS. 3A-C. As part of the legal research undertaken by the user, the user may search for a particular legal document, such as a legal case, that is stored at the case law data sources 150. As part of this search, the computing device 102 may issue a request for the particular case to the case law data sources 150, and in response, the computing device 102 may receive first case law data 170 from the case law data sources 150. The first case law data 170 is associated with a first case law document (e.g., the particular legal case being searched for by the user). The first case law data 170 may also include metadata or related information that includes details related to the legal case, such as the disposition of the legal case since it was issued. For example, the metadata or other information may indicate whether or not the legal case is indicated as being overruled or overruled in part. If the particular legal case has received any negative treatment from citing cases, such that at least one point of law in the particular legal case is no longer valid or good law, it may be indicated as being overruled in part, such as via display of a visual indicator in the GUI, as further described below. However, many legal cases contain more than one point of law, so cases that are indicated as “overruled in part” or as “partially overruled” are still citable for one or more non-overruled points of law. For this reason, if the first case law data 170 (or associated metadata or other information) indicates that the first case law document has been overruled in part, the computing device 102 may receive second case law data 172 from the case law data sources 150. The second case law data 172 is associated with a citationally-related case law document that overrules at least a portion of the first case law document.

In some implementations, in addition to providing a visual indicator (e.g., a red striped flag) in the GUI to indicate that the first case law document is overruled in part, the computing device 102 may be configured to leverage machine learning to identify the most relevant passages from both the first case law document (e.g., associated with the first case law data 170) and the citationally-related case law document (e.g., associated with the second case law data 172). As part of this process, the computing device 102 may extract features from each of the received case law documents to be used as input data to the trained ML classifiers 119. For example, the computing device 102 may extract a plurality of features from content portions 112 (e.g., multiple content portions) of first case law data 170 and second case law data 172 to generate the extracted features 110 that correspond to the content portions 112. The content portions 112 may be any portion or subdivision of the case law documents, such as sentences or paragraphs of the opinion, footnotes, citations, headnotes, or the like. The extracted features 110 may be used as input data to the trained ML classifiers 119 for generating the probability values 114 that indicate probabilities of whether the corresponding portion (from either case law document) is likely to be the most relevant passage from the case law document with respect to the overruled legal issue. For example, the computing device 102 may provide the portion of the extracted features 110 that corresponds to the content portions 112 of the citationally-related case law document (e.g., the second case law data 172) as input data to the ML classifiers 119 to generate a portion of the probability values 114 that correspond to the content portions 112 of the citationally-related case law document. Each of this portion of the probability values 114 may indicate a respective probability that a corresponding content portion of the citationally-related document, also referred to herein as the “overruling document,” is relevant to overruling at least the portion of the first case law document, which is also referred to herein as the “overruled document.”

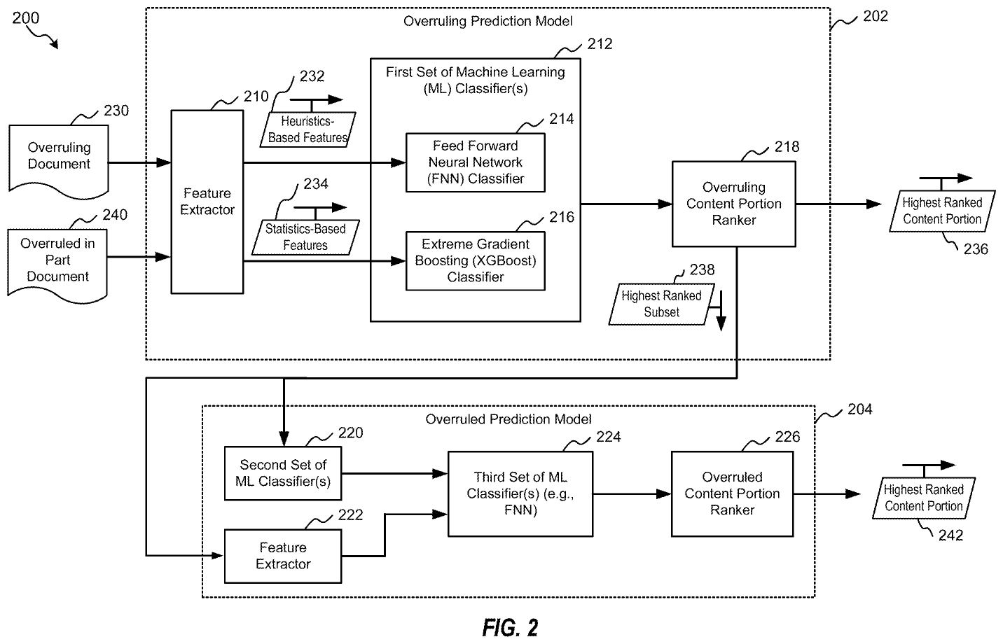

The portion of the extracted features 110 that correspond to the overruling document may include multiple types of features that are specifically selected to result in prediction of the most relevant passage(s) of the overruling document. In some implementations, the portion of the extracted features 110 that correspond to the overruling document includes a set of heuristics-based features extracted from the content portions 112 and a set of statistics-based features extracted from the content portions 112. The heuristics-based features may include one or more similarity features indicating a similarity between one or more particular headnotes and the content portions 112 of the overruling document, one or more distance features indicating a positional distance between one or more particular paragraphs and the content portions 112 of the overruling document, one or more binary features indicating whether the content portions 112 of the overruling document include particular text, other heuristic or rule-based features, or a combination thereof. The particular headnotes and/or paragraphs related to the heuristics-based features may include particular text, such as one or more overruling terms or language patterns (e.g., the words “overrules”, “overruling”, “abrogates”, “abrogating”, etc.), a citation to the first case law document, a pincite to the first case law document, or a combination thereof, as further described herein with reference to FIG. 2. The statistics-based features may include term frequency-inverse document frequency (TF-IDF) vectors generated based on the content portions 112 of the overruling document. In other implementations, other natural language processing (NLP) statistics may be used as input features.

In some implementations, the heuristics-based features and the statistics-based features of the extracted features 110 that correspond to the overruled document are provided as input data to different ML classifiers of the ML classifiers 119. For example, the ML classifiers 119 may include an ensemble of a first ML classifier and a second ML classifier, with the first ML classifier being configured to receive the heuristics-based features as the input data and to generate a first set of the probability values 114 and the second ML classifier being configured to receive the statistics-based features as the input data to generate a second set of the probability values 114. The first ML classifier may include a feed forward neural network (FNN) classifier, and the second ML classifier may include an extreme gradient boosting (XGBoost) classifier. The computing device 102 may combine the individual probability scores generated by the two ML classifiers to generate the portion of the probability values 114 that corresponds to the overruling document (e.g., the second case law data 172). Additional details of the ensemble of ML classifiers are described further below with reference to FIG. 2.

After generating the probability values 114 that correspond to the overruling document, the computing device 102 may rank the content portions 112 of the overruling document based on the associated probability values 114. For example, the computing device 102 may rank the content portions 112 of the overruling document in order of ascending or descending probability value. After the ranking, the computing device 102 may select a highest ranked content portion of the content portions 122 of the overruling document as the overruling passage 116. The overruling passage 116 may include a sentence, a paragraph, a footnote, or another portion of the overruling document (e.g., the citationally-related case law document represented by the second case law data 172) that is determined to be the most relevant passage with respect to the point of law from the overruled document (e.g., the first document represented by the first case law data 170) that is being overruled by the overruling document. The overruling passage 116 may be provided as output via the GUI, such as by displaying the overruling passage in a pop-up window, as further described below and with reference to FIGS. 3A-C.

In some implementations, in addition to selecting the highest ranked portion from the overruling document as the overruling passage 116, the computing device 102 may select a highest ranked subset of the content portions 112 of the overruling document to be used to identify portions of the overruled document. As non-limiting examples, the three or five highest ranked portions of the content portions 112 of the overruling document may be selected as the relevant portions of the overruling document, and the computing device 102 may extract a plurality of features from the highest ranked subset of the content portions 112 of the overruling document and the headnotes of the overruled document as a portion of the extracted features 110 that are to be used as input to a third ML classifier of the ML classifiers 119. In some implementations, the features extracted from the highest ranked subset of the content portions 112 of the overruling document and the headnotes of the overruled document include one or more similarity features indicating a similarity between the highest ranked subset content portions and the headnotes. In other implementations, other types of features may be extracted. The third ML classifier may be a linear classifier that is trained to receive features from the highest ranked subset of the content portions 112 of the overruling document and features from a headnote of the overruled document and, based on this input data, output one of the probability values 114. Each of these probability values 114 indicate a probability that the respective headnote of the overruled document is the most relevant headnote with respect to the point of law that is being overruled in the overruled case by the overruling case. After generating this portion of the probability values 114, the computing device 102 may rank the headnotes of the overruled documents based on the associated probability values 114 and select a highest ranked headnote as an overruled headnote, for use in identifying relevant portions of the overruled document other than the headnotes. Additional details of the features extracted from the highest ranked subset and the headnotes, and of the third ML classifier, are described further herein with reference to FIG. 2.

After selecting the overruled headnote, the computing device 102 may extract a plurality of features from the overruled headnote (e.g., the highest ranked headnote) of the overruled document and the content portions 112 of the overruled document as a portion of the extracted features 110. Similar to as described above for the overruling document, the portion of the extracted features 110 that corresponds to the overruled document (e.g., the first case law data 170) may include features that are specifically selected to result in prediction of the most relevant passage(s) of the overruled document. In some implementations, the portion of the extracted features 110 that corresponds to the overruled document includes a set of heuristics-based features that include one or more similarity features indicating a similarity between the overruled headnote and the content portions 112 of the overruled document (e.g., the first case law document represented by the first case law data 170), one or more distance features indicating a positional distance between one or more paragraphs linked to the overruled headnote and the content portions 112 of the overruled document, one or more binary features indicating whether the content portions 112 of the overruled document include holding text or language patterns (e.g., particular words, phrases, or sentence structure that indicate a holding or ruling), other features, or a combination thereof. After extracting this portion of the extracted features 110, the extracted features 110 may be provided as input data to a fourth ML classifier of the ML classifiers 119 to generate the portion of the probability values 114 that are associated with the content portions 112 of the overruled document. In some such implementations, the fourth ML classifier is a second FNN classifier. Additional details of the features extracted from the overruled document and the fourth ML classifier are described herein, with reference to FIG. 2. Each of these probability values 114 indicates a probability that the respective portion of the overruled document is the most relevant portion with respect to the point of law that is being overruled in the overruled case by the overruling case. After generating this portion of the probability values 114, the computing device 102 may rank the content portions 112 of the overruled document based on the associated probability values 114, and the computing device 102 may select the highest ranked portion from the overruled document as the overruled passage 118 (e.g., an “overruled-in-part passage”). The overruled passage 118 may include a sentence, a paragraph, a footnote, or another portion of the overruled document (e.g., the citationally-related case law document) that is the most relevant to the point of law or holding that is being overruled in the overruled document by the overruling document.

After identifying the overruling passage 116 and the overruled passage 118, the computing device may display a GUI that includes the overruling passage 116, the overruled passage 118, or both. For example, based on selection of the overruled case by the user, the computing device 102 may cause the GUI to display a summary page related to the overruled case with a displayable indicator, such as a red striped flag, that indicates that the retrieved case has been overruled in part. If the user selects the displayable indicator, the GUI may automatically scroll to the overruled passage 118, the GUI may highlight or visibly indicate the overruled passage 118, or a combination thereof. In some implementations, the computing device 102 may cause display of a second displayable indicator in the GUI nearby the overruled passage 118 that indicates that the overruled case has been overruled in part, and upon selection of the second displayable indicator, the computing device 102 may cause the GUI to display the overruling passage 116, such as via a pop-up window or in some other manner. As such, the user may be able to determine, from the presences of the displayable indicator, that the legal case that was the subject of their search has been overruled in part by a more recent case, and by selecting the displayable indicator, the user may be taken to the most relevant passage in the overruled case and be presented with the most relevant passage in the overruling case, such that they may quickly ascertain whether the point of law they wished to rely on this case for is still valid, without time consuming reading of both documents. Additional details of the GUI are described further herein, with reference to FIGS. 3A-C.

As described above, the system 100 supports identifying overruled in part content based on citationally related content. For example, a legal research tool executed by the computing device 102 may receive the first case law data 170 and the second case law data 172 and use the received case law data to generate the extracted features 110. The extracted features 110 may be used as input to the ML classifiers 119 to generate the probability values 114 that correspond to the content portions 112 of the overruled document and the overruling document. The respective document content portions may be ranked based on the associated probability values 114 to identify the overruling passage 116 and the overruled passage 118. By outputting the overruling passage 116 and the overruled passage 118, the system 100 enables a user (e.g., a legal researcher or lawyer) to identify the most relevant portion of the overruling document and the overruled document without requiring manual review of the entireties of both documents, thereby increasing the utility and user experience of the legal research tool. Additionally, the overruling passage 116 and the overruled passage 118 are identified with greater accuracy than other legal research systems that merely perform keyword searches of the documents. Thus, the legal research tool supported by the system 100 improves the functioning of the computing device 102 as compared to other legal research systems. As a non-limiting example, the computing device 102 may display a graphical indicator, such as a striped red flag, along with the name of the overruled case in the GUI to indicate that the second case law document has been overruled in part, as compared to if the second case law document were fully overruled, which may be indicated by a solid red flag. Selection of the graphical indicator may cause the GUI to automatically scroll the overruled document to the overruled passage 118, which may be visually indicated, and selection of another visual indicator may cause display (e.g., in a pop-up window or the like) of the overruling passage 116 from the overruling document. As such, the system 100 may implement a legal research tool that enables quick and efficient identification of highly relevant portions of citationally related documents without requiring manual review of the entirety of the documents, and with increased accuracy as compared to other legal research systems. These advancements in the field of legal and information research technology may enable a user to rely upon information from documents that are overruled in part, as compared to legacy research systems that only indicated whether a legal document was clean or overruled, likely resulting in the user being unable to rely on legal documents that contained at least some still valid points of law.

Referring to FIG. 2, examples of prediction models for identifying overruled in part content based on citationally related content according to one or more aspects are shown as prediction models 200. Components of prediction models 200 illustrated in FIG. 2 may include or correspond to one or more components of system 100 of FIG. 1, such as ML classifiers 119. In the example shown in FIG. 2, the prediction models 200 include an overruling prediction model 202 and an overruled prediction model 204. The overruling prediction model 202 and the overruling prediction model 204 may each include one or more respective ML classifiers, and each are configured to receive a respective one of an overruled-overruling document pair and to output a respective most relevant passage of the input document. For example, the overruling prediction model 202 may be configured to receive an input dataset that includes the overruling document 230 and to output a highest ranked content portion 236 of the overruling document 230. In an aspect, the input dataset provided to the overruling prediction model 202 may also include an overruled in part document 240. The overruled prediction model 204 may be configured to receive the output of the overruling prediction model 202 as input, which may include information indicating a highest ranked content portion 242 of the overruled in part document 240. Similar to the examples described above with reference to FIG. 1, the overruled in part document 240 may be a legal case, such as a legal case, a judicial opinion, a document of legal scholarship, or the like, that contains multiple points of law and for which only a single point of law (or a subset of the points of law) are overruled or treated negatively by the overruling document 230. Thus, a user of a legal research tool that implements the prediction models 200 may be able to rely on the overruled in part document 240, which may be returned as part of search results to a legal research query, as long as the user does not rely on the overruled in part document 240 for the point of law that is overruled by the overruling document 230.

The overruling prediction model 202 may include a feature extractor 210, a first set of ML classifiers 212, and an overruling content portion ranker 218. The first set of ML classifiers 212 may include an ensemble of a first ML classifier and a second ML classifier. The feature extractor 210 may be configured to extract one or more types of features from the input dataset (e.g., the overruling document 230 and the overruled in part document 240) to be used as input data to the first set of ML classifiers 212. The first set of ML classifiers 212 are configured to output probability values that represent a probability that a respective portion of the overruling document 230 is the most relevant passage of the overruling document 230 with respect to the point of law of the overruled in part document 240 that is overruled by the overruling document 230. In some implementations, the first ML classifier 214 is a feed forward neural network (FNN) classifier and the second ML classifier 216 is an extreme gradient boosting (XGBoost) classifier. The overruling content portion ranker 218 may be configured to rank the content portions of the overruling document 230 based on the probability values, such as in increasing or decreasing order of probability. The highest ranked portion may be output as the highest ranked content portion 236 of the overruling document 230 (e.g., an overruling passage, which may include a sentence, a paragraph, a footnote, or the like, from the overruling document 230). A highest ranked subset 238 of portions of the overruling document 230 may be output to the overruled prediction model 204, such as the three, four, or five highest ranked portions, as non-limiting examples.

The overruled prediction model 204 may include a second set of ML classifiers 220, a feature extractor 222, a third set of ML classifiers 224, and an overruled content portion ranker 226. The second set of ML classifiers 220 may include one or more ML classifiers that are configured to receive features extracted from the highest ranked subset 238 and to output a prediction (e.g., a probability value) of a most relevant headnote from the overruled in part document 240. The headnotes may be ranked based on the probability values to select a highest ranked headnote (e.g., an “overruled headnote”). In some implementations, the second set of ML classifiers 220 includes a single linear classifier (e.g., a third ML classifier). The feature extractor 222 may be configured to extract one or more types of features from the overruled in part document 240 to be used as input data to the third set of ML classifiers 224. The third set of ML classifiers 224 are configured to output probability values that represent a probability that a respective portion of the overruled in part document 240 is the most relevant passage of the overruled in part document 240 with respect to the point of law in the overruled in part document 240 that is overruled by the overruling document 230. In some implementations, the third set of ML classifiers 224 include a single FNN classifier (e.g., a fourth ML classifier). The overruled content portion ranker 226 may be configured to rank the content portions of the overruled in part document 240 based on the probability values, such as in increasing or decreasing order of probability. The highest ranked portion may be output as the highest ranked content portion 242 of the overruled in part document 240 (e.g., an overruled passage, which may include a sentence, a paragraph, a footnote, or the like, from the overruled in part document 240).

During operation of the prediction models 200, the overruling document 230 may be input to the feature extractor 210 to generate heuristics-based features 232 and statistics-based features 234. The heuristics-based features 232 may include one or more similarity features indicating a similarity between one or more specific headnotes of the overruling document 230 that include overruling terms or language patterns, or a pincite to the overruled in part document 240, and the content portions of the overruling document 230, one or more distance features indicating a positional distance between one or more specific paragraphs of the overruling document 230 that include overruling terms or language patterns, or a pincite to the overruled in part document 240, and the content portions of the overruling document 230, one or more binary features indicating whether the content portions of the overruling document 230 include particular text, or a combination thereof wherein the one or more particular headnotes include the overruling terms or language patterns, or a pincite to the overruled in part document 240, or a combination thereof. The statistics-based features 234 may include TF-IDF vectors generated based on the content portions of the overruling document 230. The heuristics-based features 232 may be input to the FNN classifier 214 to generate a first set of probability values that correspond to portions of the overruling document 230, and the statistics-based features 234 may be input to the XGBoost classifier 216 to generate a second set of probability values that correspond to the portions of the overruling document 230. For example, the FNN classifier 214 may generate probability values based on the heuristics-based features 232 (e.g., “handcrafted features” that are tested and selected for use in the prediction models 200) and the XGBoost classifier 216 may generate probability values based on the statistics-based features 234 (e.g., TF-IDF vectors) to capture n-grams to be used to generate the probability values. The overruling content portion ranker 218 may combine the first set of probability values with the second set of probability values to generate a combined set of probability values, such as summing the respective first and second probability values for each content portion, and the content portions of the overruling document 230 may be ranked in order based on their respective combined probability values. The overruling content portion ranker 218 may output the highest ranked content portion 236 (e.g., for display to the user via a GUI) and may output the highest ranked subset 238 of content portions of the overruling document 230 to the overruled prediction model 204. The second set of ML classifiers 220 (e.g., the linear classifier) may receive the highest ranked subset 238 and features extracted from the headnotes of the overruled in part document 240 to output a set of probability values that correspond to the headnotes of the overruled in part document 240. The headnotes may be ranked based on the corresponding probability values, and the highest ranked headnote may be provided as input to the third set of ML classifiers 224. The third set of ML classifiers 224 may also receive as input features extracted by the feature extractor 222 from the overruled in part document 240 and the highest ranked headnote. These features are based on linguistic, structural, and editorial information associated with the original citation relationship and the citing/cited case pair (e.g., the overruling document 230 and the overruled in part document 240). Based on these input features, the third set of ML classifiers 224 (e.g., the second FNN classifier) may output probability values that correspond to portions of the overruled in part document 240. The overruled content portion ranker 226 may rank the content portions of the overruled in part document 240 in order based on their respective probability values, and, after the ranking, the overruled content portion ranker 226 may output the highest ranked content portion 242 (e.g., for display to the user via a GUI).

The prediction models 200 may be trained to select the features that, when extracted, provide the best ranking of overruled and overruling passages using unsupervised ML models based on text similarity. These ML models may be used as a baseline and subsequent training may be performed based on a data set of manually annotated overruling/overruled in part case pairs created by subject matter experts. Identification of the overruled content portions may then be framed as a problem involving three sequential ranking tasks. First, the relevant overruling language is detected from the citing case (e.g., the overruling document 230) by classifying opinion paragraphs. Next, relevant headnotes in the cited case (e.g., the overruled in part document 240) are identified, and then opinion paragraphs from the cited case (e.g., the overruled in part document 240) are ranked and identified.

To solve the above-described problem, a machine learning model (e.g., the prediction models 200) that predicts the text pertaining to the rule or point of law being overruled on both sides (e.g., overruling and overruled) may be constructed. The overruling document 230 may be used as a starting point to identify the relevant text using an AI solution (e.g., the overruling prediction model 202) that is based on the nature of text of the overruling document 230, which often includes overruling language and citations to the overruled in part document 240. Next, an AI model (e.g., the overruled prediction model 204) for the overruled in part document 240 receives as input features that indicate the relationship between the two cases and predictions (e.g., the highest ranked subset 238) from the overruling prediction model 202. For this arrangement, a supervised training approach may be used, where Subject Matter Experts (SMEs) manually identified relevant texts (e.g., highly relevant passages) of both overruling cases and overruled cases as labeled case pairs (e.g., the above-described dataset created by the SMEs). With these texts, the prediction models 200 may be trained to identify similar texts (e.g., highly relevant passages) for the overruling document 230 and the overruled in part document 240 (e.g., for new case pairs).

To illustrate the complexities associated with training the models, consider that many cases involve multiple legal issues, but for partially overruled cases only some of those legal issues are overruled, resulting in a partially overruled case having one or more legal issues that are not overruled and one or more legal issues that are overruled. Thus, some portions of a partially overruled case remain valid, while the portions pertaining to overruled legal issues are invalid. It is important that the models be able to accurately identify not only which legal issues have been overruled (and conversely, which have not), but to identify the portions of the partially overruled cases involving the overruled legal issues and the portions of the overruling in part cases explaining why those legal issues were overruled. During the above-described training the models described herein may learn to extract features from overruling and overruled cases that enable the models to identify the relevant portions of the overruling and overruled cases for the one or more legal issues that have been overruled, thereby enabling the models to distinguish between cases that have been overruled in part.

In an aspect, the training dataset described above may be pruned of duplicate case pairs, as well as any case pairs that did not include any relevant text passages. The annotations of the remaining documents (which were generated by the SMEs) may include case pairs that are partially overruled, as compared to being fully overruled. To enable the models to be trained to identify the relevant passage indicating the point of law that has been overruled, as not all point of laws are overruled by the citing cases, the training dataset may include cases where there is only one issue that is being overruled and case pairs having two overruling issues. In an aspect, the dataset may not include cases where there were three or more overruling issues, which may be statistically unlikely to occur and may introduce noise into the dataset. In an aspect, the dataset may include overruling cases having at least two relevant passages (e.g., paragraphs in which the overruled legal issue is addressed) and overruled cases having at least three relevant passages (e.g., paragraphs in which the overruled legal issue is discussed). The dataset may include relevant headnotes in addition to passages from the opinions or footnotes. As headnotes may be generated in-house by SMEs or automated systems, the prediction models 200 may be trained to identify relevant passages from the opinion segments and footnotes. Such information may provide additional datapoints that may enable identification of the relevant portions of overruling cases and overruled cases with respect to the legal issue(s) involved (e.g., discussion of the overruled legal issue in the overruled case and the analysis of the legal issue in the overruling case). In other implementations, feature selection may be tailored by based on characteristics of legal documents in other jurisdictions. In an aspect, the annotations applied to the training dataset may include headnotes, portions of the opinion or case, and footnotes, but the number of labels or annotations for the overruled cases and the overruling cases for each of these different features may be different (e.g., the composition of annotations related to headnotes, portions of the opinion, footnotes, etc. may be different for overruled cases as compared to overruling cases). In an aspect, the annotations or labels may also indicate if the content (e.g., paragraphs, headnotes, footnotes, or a combination thereof) are relevant or highly relevant (e.g., to the discussion of the overruled legal issue in the overruled and/or overruling cases). By incorporating headnotes into the training data the models may be enabled to learn to identify overruled and overruling cases more efficiently. For example, overruling cases may include overruling language such as “overrule” (or other forms of the verb), “abrogate” (or other forms of the verb), etc. when discussing the overruled case, thereby providing concrete language that may be used to enable learning by the model. Furthermore, the various features described above regarding the training dataset may enable a point-wise ranking approach on both sides of the case (e.g., the overruling and the overruled sides), where each portion (e.g., paragraph, sentence, section, etc.) in the opinion is ranked and the highest ranked portion is selected as the relevant passage. A comparable approach is followed for both sides of the case using the overruling prediction model 202 and the overruled prediction model 204, respectively.

As the baseline approach showed that the similarity between specific headnotes of the overruling cases and opinion passages of the overruling cases is a strong feature in identifying relevant opinion passages in new overruling cases, several features were identified that exploit this idea. As non-limiting examples, the specific overruling headnote might include attributes such as overruling language (e.g., words such as overruling, abrogating, etc.), a full citation to the overruled in part document 240, or a pincite (e.g., a partial or condensed citation) to the overruled in part document 240. For each headnote identified for a specific attribute, similarity features were generated between the headnote and each opinion portion of the overruling document 230. Similarly, positional distance-based features are generated by identifying specific portions within the opinion or footnotes of the overruling document 230. These specific opinion portions might include attributes such as a reference to an overruling headnote, a citation to the overruled in part document 240, overruling language or structure, or a pincite to the overruled in part document 240. Using these specific opinion portions, positional features may be generated by calculating the distance between each specific opinion portion to all other portions in the overruling document 230. Binary features may also be generated, such as binary features indicating if a respective portion includes a specific language pattern or overruling language, citation to the overruled in part document 240, etc. These features may be extracted to generate the heuristics-based features 232.

Examples of the heuristics-based features 232 are present in Table 1 below. The name, type of feature, and a short description of the feature are presented. The heuristics-based features 232 may include similarity features, binary features, and distance features. The similarity features may indicate the similarity of each portion in the opinion segment of the overruling document 230 with respect to selected overruling headnotes (as described above), overruling holdings, and each other portion in the overruled document 230. The binary features may indicate the presence or absence of a linguistic cue, citation or a pincite, or the like. The distance features may indicate the distance of each overruling opinion portion of the overruling document 230 with respect to the selected overruling headnotes, overruling holdings or citations and pincites, and other portions of the overruling document 230. These features may be used as input to the FNN classifier 214.

TABLE 1
Heuristics-Based Features from Overruling Case

| No. | Feature | Type | Description |
|---|---|---|---|
| 1 | X_CASE_HAS_A_CITING_HEADNOTE | bool | True if this overruling case has a headnote |
| | | | that cites the overruled case, otherwise False. |
| | | | The default value is false |
| 2 | X_CITING_HN_REF_IN_SECTION | bool | True if this paragraph's section has a |
| | | | paragraph that is linked to a headnote |
| | | | containing overruled citation, otherwise |
| | | | False. The default value is nan |
| 3 | X_CITING_PARA_JACCARD_SIM_TOP1 | float | Indicates the maximum Jaccard similarity |
| | | | between this paragraph and any overruling |
| | | | paragraph that cites the overruled case. The |
| | | | default value is nan |
| 4 | X_CITING_PARA_SIM_MAX1 | float | Indicates the maximum cosine similarity of |
| | | | this paragraph to any citing paragraphs. The |
| | | | default value is nan |
| 5 | X_HAS_ABROGATED_DECISION_PATTERN | bool | True if this paragraph has this pattern, |
| | | | otherwise False |
| 6 | X_HAS_FEDERAL_CITE_PATTERN | bool | True if this paragraph has this pattern, |
| | | | otherwise False |
| 7 | X_HAS_IS_DISAVOWED_PATTERN | bool | True if this paragraph has this pattern, |
| | | | otherwise False |
| 8 | X_HAS_OVERRULING_KEYWORD | bool | True if this paragraph has overruling |
| | | | language, otherwise False |
| 9 | X_HAS_OVERRULING_KEYWORD_IN_LINKED_HN | bool | True if this paragraph has this pattern, |
| | | | otherwise False |
| 10 | X_HAS_PRIOR_CASE_PATTERN | bool | True if this paragraph has this pattern, |
| | | | otherwise False |
| 11 | X_HAS_RECEDE_FROM_PATTERN | bool | True if this paragraph has this pattern, |
| | | | otherwise False |
| 12 | X_HAS_TO_THE_EXTENT_PATTERN | bool | True if this paragraph has this pattern, |
| | | | otherwise False |
| 13 | X_HAS_WE_OVERRULE_PATTERN | bool | True if this paragraph has this pattern, |
| | | | otherwise False |
| 14 | X_HAS_WRONGLY_DECIDED_PATTERN | bool | True if this paragraph has this pattern, |
| | | | otherwise False |
| 15 | X_KEYCITED_HN_COSINE_SIM_MAX1 | float | Indicates the largest cosine similarity |
| | | | between this paragraph and any keycited |
| | | | headnotes. The default value is nan |
| 16 | X_KEYCITED_HN_COSINE_SIM_MAX2 | float | Indicates the second-largest cosine similarity |
| | | | between this paragraph and any keycited |
| | | | headnotes. The default value is nan |
| 17 | X_MIN_DIST_FROM_CITING_HN_REF | int | Indicates the minimum distance from any |
| | | | paragraph that is linked to a headnote |
| | | | containing overruled citation to this |
| | | | paragraph. The default value is nan |
| 18 | X_MIN_DIST_FROM_O_CITE | int | Indicates the minimum distance from any |
| | | | paragraph that contains overruled citation to |
| | | | this paragraph. The default value is nan. |
| 19 | X_MIN_DIST_FROM_O_PINCITE | int | Indicates the minimum distance from any |
| | | | paragraph that contains overruled pinpoint |
| | | | citation to this paragraph. The default value |
| | | | is nan. |
| 20 | X_MIN_DIST_TO_CITING_HN_REF | int | Indicates the minimum distance from this |
| | | | paragraph to any paragraph that is linked to a |
| | | | headnote containing overruled citation. The |
| | | | default value is nan. |
| 21 | X_MIN_DIST_TO_O_CITE | int | Indicates the minimum distance from this |
| | | | paragraph to any paragraph that contains |
| | | | overruled citation. The default value is nan. |
| 22 | X_MIN_DIST_TO_O_PIN_CITE | int | Indicates the minimum distance from this |
| | | | paragraph to any paragraph that contains |
| | | | overruled pinpoint citation. The default value |
| | | | is nan. |
| 23 | X_NUM_OF_WORDS | int | Indicates the number of words in the given |
| | | | overruling paragraph. The default value is 0. |
| 24 | X_OVERRULING_HN_JACCARD_SIM_TOP1 | float | Indicates the maximum Jaccard similarity |
| | | | between this paragraph and any overruling |
| | | | headnotes. The default value is nan. |
| 25 | X_OVERRULING_HN_SIM_MAX1 | float | Indicates the maximum cosine similarity of |
| | | | this paragraph to any overruling headnotes. |
| | | | The default value is nan. |
| 26 | X_OVERRULING_HOLDING_JACCARD_SIM_TOP1 | float | Indicates the maximum Jaccard similarity |
| | | | between this paragraph and any overruling |
| | | | holdings. The default value is nan. |
| 27 | X_OVERRULING_HOLDING_SIM_MAX1 | float | Indicates the maximum cosine similarity of |
| | | | this paragraph to any overruling holdings. |
| | | | The default value is nan. |
| 28 | X_OVERRULING_PATTERNS_NUM_MATCHES | int | Indicates the number of overruling patterns |
| | | | found in this paragraph. |
| 29 | X_O_CITE_IN_SECTION | bool | True if this paragraph's section contains |
| | | | overruled citation, otherwise False. The |
| | | | default value is False. |
| 30 | X_O_PIN_CITE_IN_SECTION | bool | True if this paragraph's section contains |
| | | | overruled pinpoint citation, otherwise False. |
| | | | The default value is False. |
| 31 | X_PARAGRAPH_COSINE_SIM_MAX1 | float | Indicates the largest cosine scores from |
| | | | comparing this paragraph to each paragraph |
| | | | in the overruled opinion. The default value is |
| | | | nan. |
| 32 | X_PARAGRAPH_COSINE_SIM_MAX2 | float | Indicates the second-largest cosine scores |
| | | | from comparing this paragraph to each |
| | | | paragraph in the overruled opinion. The |
| | | | default value is nan. |
| 33 | X_PARAGRAPH_COSINE_SIM_MAX3 | float | Indicates the third-largest cosine scores from |
| | | | comparing this paragraph to each paragraph |
| | | | in the overruled opinion. The default value is |
| | | | nan. |
| 34 | X_PARAGRAPH_JACCARD_SIM_TOP1 | float | Indicates the maximum Jaccard similarity |
| | | | between this paragraph and any overruled |
| | | | paragraphs. The default value is nan. |
| 35 | X_PARAGRAPH_JACCARD_SIM_TOP2 | float | Indicates the second maximum Jaccard |
| | | | similarity between this paragraph and any |
| | | | overruled paragraphs. The default value is |
| | | | nan. |
| 36 | X_PARAGRAPH_JACCARD_SIM_TOP3 | float | Indicates the third maximum Jaccard |
| | | | similarity between this paragraph and any |
| | | | overruled paragraphs. The default value is |
| | | | nan. |
| 37 | X_PARA_WITH_CITING_REF_JACCARD_SIM_TOP1 | float | Indicates the maximum Jaccard similarity |
| | | | between this paragraph and any overruling |
| | | | paragraph linked to a citing headnote. The |
| | | | default value is nan. |
| 38 | X_PARA_WITH_CITING_REF_SIM_MAX1 | float | Indicates the maximum cosine similarity of |
| | | | this paragraph and any paragraph containing |
| | | | citation in the linked headnote. The default |
| | | | value is nan. |
| 39 | X_CASE_HAS_A_CITING_HEADNOTE | bool | True if this overruling case has a headnote |
| | | | that cites the overruled case otherwise False. |
| 40 | X_ENTITIES_PER_SENT | float | The average number of named entities per |
| | | | sentence in this paragraph. Default is 0. |
| 41 | X_FIRST_PERSON_SUBJ_PER_SENT | float | The average number of specific (targeted) |
| | | | first person main verb subjects per sentence. |
| | | | Default is 0. |
| 42 | X_FIRST_ROOT_PAST_TENSE | bool | True if the first root verb of the paragraph |
| | | | has past tense. Default is False |
| 43 | X_FIRST_SUBJ_NAMED_ENTITY | bool | True if the subject of the first root verb in the |
| | | | paragraph is part of a named entity. Default |
| | | | is False |
| 44 | X_NUM_CITES_IN_PARA | int | Number of unique cases cited by this |
| | | | paragraph |
| 45 | X_NUM_COMMON_CITES_IN_PARA | int | Number of unique cases cited by this |
| | | | paragraph which are also cited by the |
| | | | overruled case |
| 46 | X_NUM_OF_WORDS_IN_XHOLDING | int | Indicates the number of words in the |
| | | | overruling holding. The default value is 0 |
| 47 | X_RATIO_PAST_TENSE_ROOTS | float | Fraction of root verbs in past tense that occur |
| | | | in this paragraph. Default is 0 |

Examples of features extracted by the feature extractor 222 from the overruled in part document 240 are presented in Table 2 below. The name, type of feature, and a short description of the feature are presented. These features may include similarity features, binary features, and distance features. In addition to the similarity features that are analogous to the similarity features extracted from the overruling document 230, additional similarity features are extracted from the overruled in part document 240 with respect to particular headnotes identified by the second set of ML classifiers 220 and the highest ranked subset 238 of portions of the overruling document 230. The binary features and the distance features extracted from the overruled in part document 240 are comparable to the corresponding features extracted from the overruling document 230. These features may be used as input to the third set of ML classifiers 224 (e.g., the second FNN classifier).

TABLE 2
Heuristics-Based Features from Overruled Case

| No. | Feature | Type | Description |
|---|---|---|---|
| 1 | O_CITING_PARA_JACCARD_SIM_TOP1 | float | Indicates the maximum Jaccard similarity |
| | | | between this paragraph and any overruling |
| | | | paragraph that cites the overruled case. The |
| | | | default value is nan. |
| 2 | O_CITING_PARA_SIM_MAX1 | float | Indicates the maximum cosine similarity of |
| | | | this paragraph to any citing paragraphs. The |
| | | | default value is nan. |
| 3 | O_KEYCITED_HN_COSINE_SIM_MAX1 | float | Indicates the largest similarity of this |
| | | | paragraph to any keycited headnotes. The |
| | | | default value is nan. |
| 4 | O_KEYCITED_HN_COSINE_SIM_MAX2 | float | Indicates the second-largest similarity of this |
| | | | paragraph to any keycited headnotes. The |
| | | | default value is nan. |
| 5 | O_KEYCITED_REF_IN_SECTION | bool | True if this paragraph's section has a |
| | | | paragraph that is linked to a keycited |
| | | | headnote, otherwise False. The default value |
| | | | is False. |
| 6 | O_LINKED_PARA_IN_SECTION | bool | True if this paragraph's section has a |
| | | | paragraph that is linked to the overruled |
| | | | headnote, otherwise False. The default value |
| | | | is False. |
| 7 | O_MIN_DIST_FROM_KEYCITED_REF | int | Indicates the minimum distance from any |
| | | | paragraph that is linked to a keycited |
| | | | headnote to this paragraph. The default value |
| | | | is nan. |
| 8 | O_MIN_DIST_FROM_LINKED_PARA | int | Indicates the minimum distance from any |
| | | | paragraph linked to the overruled headnote to |
| | | | this paragraph. The default value is nan. |
| 9 | O_MIN_DIST_FROM_PIN_CITED_PAGE | int | Indicates the minimum distance from any |
| | | | paragraph that is pincited by the overruling |
| | | | case to this paragraph. The default value is |
| | | | nan. |
| 10 | O_MIN_DIST_TO_KEYCITED_REF | int | Indicates the minimum distance from this |
| | | | paragraph to any paragraph that is linked to a |
| | | | keycited headnote. The default value is nan. |
| 11 | O_MIN_DIST_TO_LINKED_PARA | int | Indicates the minimum distance from this |
| | | | paragraph to any paragraph linked to the |
| | | | overruled headnote. The default value is nan. |
| 12 | O_MIN_DIST_TO_PIN_CITED_PAGE | int | Indicates the minimum distance from this |
| | | | paragraph to any paragraph that is pincited |
| | | | by the overruling case. The default value is |
| | | | nan. |
| 13 | O_NUM_COMMON_CITES_IN_PARA | int | Number of unique cases cited by this |
| | | | paragraph which are also cited by the |
| | | | overruling case. |
| 14 | O_OVERRULING_HN_JACCARD_SIM_TOP1 | float | Indicates the maximum Jaccard similarity |
| | | | between this paragraph and any overruling |
| | | | headnotes. The default value is nan. |
| 15 | O_OVERRULING_HN_SIM_MAX1 | float | Indicates the maximum cosine similarity of |
| | | | this paragraph to any overruling headnotes. |
| | | | The default value is nan. |
| 16 | O_OVERRULING_HOLDING_JACCARD_SIM_TOP1 | float | Indicates the maximum Jaccard similarity |
| | | | between this paragraph and any overruling |
| | | | holdings. The default value is nan. |
| 17 | O_OVERRULING_HOLDING_SIM_MAX1 | float | Indicates the maximum cosine similarity of |
| | | | this paragraph to any overruling holdings. |
| | | | The default value is nan. |
| 18 | O_PARAGRAPH_COSINE_SIM_MAX1 | float | Indicates the largest cosine similarity scores |
| | | | between this paragraph and paragraphs in the |
| | | | overruling opinion. The default value is nan. |
| 19 | O_PARAGRAPH_COSINE_SIM_MAX2 | float | Indicates the second-largest cosine similarity |
| | | | scores between this paragraph and |
| | | | paragraphs in the overruling opinion. The |
| | | | default value is nan. |
| 20 | O_PARAGRAPH_COSINE_SIM_MAX3 | float | Indicates the third-largest cosine similarity |
| | | | scores between this paragraph and |
| | | | paragraphs in the overruling opinion. The |
| | | | default value is nan. |
| 21 | O_PARAGRAPH_JACCARD_SIM_TOP1 | float | Indicates the maximum Jaccard similarity |
| | | | between this paragraph and any overruling |
| | | | paragraphs. The default value is 0. |
| 22 | O_PARAGRAPH_JACCARD_SIM_TOP2 | float | Indicates the second-maximum Jaccard |
| | | | similarity between this paragraph and any |
| | | | overruling paragraphs. The default value is 0. |
| 23 | O_PARAGRAPH_JACCARD_SIM_TOP3 | float | Indicates the third-maximum Jaccard |
| | | | similarity between this paragraph and any |
| | | | overruling paragraphs. The default value is 0. |
| 24 | O_PARA_WITH_CITING_REF_JACCARD_SIM_TOP1 | float | Indicates the maximum Jaccard similarity |
| | | | between this paragraph and any overruling |
| | | | paragraph that is linked to a citing headnote. |
| | | | The default value is nan. |
| 25 | O_PARA_WITH_CITING_REF_SIM_MAX1 | float | Indicates the maximum cosine similarity of |
| | | | this paragraph to any paragraph containing |
| | | | citation in the linked headnote. The default |
| | | | value is nan. |
| 26 | O_PIN_CITED_PAGE_IN_SECTION | bool | True if this paragraph's section has a |
| | | | paragraph that is pincited by the overruling |
| | | | case, otherwise False. The default value is |
| | | | False. |
| 27 | O_FIRST_PERSON_SUBJ_PER_SENT | float | The average number of specific (targeted) |
| | | | first person main verb subjects per sentence. |
| | | | Default is 0. |
| 28 | O_FIRST_SENT_TARGET_SIM | float | Similarity of the first substantive sentence in |
| | | | this paragraph compared to the most relevant |
| | | | text. |
| 29 | O_OVERRULING_HN_JACCARD_SIM_TOP1 | float | Indicates the maximum Jaccard similarity |
| | | | between this paragraph and any overruling |
| | | | headnotes. |
| 30 | O_OVERRULING_HN_SIM_MAX1 | float | Indicates the maximum cosine similarity of |
| | | | this paragraph to any overruling headnotes. |
| 31 | O_SELECTED_X_PARA_COSINE_SIM_MAX | float | Indicates the max cosine similarity between |
| | | | this paragraph and all selected overruling |
| | | | paragraphs. |
| 32 | O_SELECTED_X_PARA_COSINE_SIM_SUM | float | Indicates the sum cosine similarities between |
| | | | this paragraph and all selected overruling |
| | | | paragraphs. |
| 33 | O_SELECTED_X_PARA_JACCARD_SIM_SUM | float | Indicates the sum of Jaccard similarities |
| | | | between this paragraph and all selected |
| | | | overruling paragraphs. |
| 34 | O_ANY_OVERRULED_PATTERNS_MATCH | bool | Indicates if any typical holding language |
| | | | patterns are found in the overruled |
| | | | paragraph. |
| 35 | O_FIRST_ROOT_PAST_TENSE | bool | True if the first root verb of the paragraph |
| | | | has past tense. Default is False. |

Unlike for the overruling document 230, where the overruling headnote can be identified relatively straightforwardly using rule-based approaches based on detection of citations, overruling language or structure, etc., the second set of ML classifiers 220 are used to predict the highest ranked (e.g., most relevant) headnote of the overruled in part document 240. These features represent the similarities between each headnote in the overruled in part document 240 and the highest ranked subset 238 of portions from the overruling document 230, the and in some implementations, the holding and selected headnotes of the overruling document 230. These features may be used as input to the second set of ML classifiers 220 (e.g., the linear classifier) and are presented in Table 3 below.

TABLE 3
Features for Predicting Headnote from Overruled Case

| Feature | Type | Description |
|---|---|---|
| OHN_ABSTRACT | bool | True if this headnote is abstract, otherwise |
| | | False |
| OHN_KEYCITED | bool | True if this headnote is keycited, otherwise |
| | | False |
| OHN_XHN_JACCARDSIM | float | Indicates the maximum Jaccard similarity |
| | | between this headnote and any overruling |
| | | headnote. The default value is nan |
| OHN_XHN_KEYNUM_JACCARDSIM | float | Indicates the maximum Jaccard similarity |
| | | between this headnote keynumber's |
| | | catchline and any overruling headnote |
| | | keynumber's catchline. The default value is |
| | | nan |
| OHN_XHOLDING_JACCARDSIM | float | Indicates the maximum Jaccard similarity |
| | | between this headnote and any overruling |
| | | holdings. The default value is nan |

The above-described features are extracted and used as input to the various classifiers of the prediction models 200. For example, the first set of ML classifiers 212 may classify each portion (e.g., paragraph, sentence, section, etc.) of the overruling document 230 as relevant or irrelevant. Regardless of the label produced by the first set of ML classifiers 212 for a portion, a probability value is also output, and the portions are ranked based on the probability values. The first set of ML classifiers 212 (e.g., a binary classifier) may be an ensemble of two models; the FNN classifier 214 and the XGBoost classifier 216. The FNN classifier 214 may receive as input any or all of features included in Table 1, and it may have one hidden layer. The final layer may have a sigmoid function which outputs probabilities between 0 and 1. The XGBoost classifier 216 may receive as input the statistics-based features 234 (e.g., TF-IDF vectors) generated based on the portions of the overruling document 230. The probabilities output by the two classifiers may be added or otherwise combined, and the portions of the overruling document 230 may be ranked based on the combined probability values. In some implementations, the overruling prediction model 202 outputs the highest ranked portion as the highest ranked content portion 236 and the three highest ranked portions as the highest ranked subset 238. The second set of ML classifiers 220 (e.g., the linear classifier) may receive as input the features described in Table 3 to output probability values that correspond to the headnotes of the overruled in part document 240. A similar ranking approach is followed, and the highest ranked headnote is selected as the overruled relevant headnote. This headnote is used to generate features that are provided as input to the third set of ML classifiers 224 (e.g., the second FNN classifier). The third set of ML classifiers 224 may receive as input the features described in Table 2. The second FNN classifier (e.g., the third set of ML classifiers 224) may be structurally similar to the FNN classifier 214. An ensemble with another XGBoost classifier was not used, as the probabilities from such a classifier were not helpful in the training and validating of the prediction models 200. In other implementations, additional statistics-based features (e.g., TF-IDF vectors) may be extracted from the overruled in part document 240, and the third set of ML classifiers 224 may include an ensemble of the second FNN classifier and an additional XGBoost classifier. In this manner, the feature selection and classifier design described above enables a legal research tool to identify the most relevant portions of both an overruling legal case and an overruled in part legal case, which provides improved utility to a user than other legal research tools and systems.

The following description explains how annotations were generated from case law pairs for use in generating training data to train the prediction models 200. In some implementations, one or more of the annotations described below may not be included in case law data that is used to train the prediction models 200, or other additional annotations may be added, without departing from the scope of the present application. The annotation process was performed by SMEs to find the most relevant text in both overruling cases and related overruled cases, which pertains to the rule or point of law being overruled. However, in other implementations, some or all of the annotations may be generated by an automated process, such as leveraging machine learning or artificial intelligence, or by a hybrid SME and automated process.

The annotators start with an overruling case and check if any of the headnotes explicitly mention “overruling” or “abrogating” or some other language indicating an overruling of a point of law from the overruled case. If so, the SME could use the link in the headnote number to automatically scroll down to the portion of the opinion text containing the discussion of the point of law and the case citation(s) being overruled. The SME may read the text around these citations carefully and, if no such explicit overruling language is found amongst the headnotes, the SME begins reading the opinion to look for the overruling language. The headnotes may still be used as jumping off points to link to portions of the overruling case opinion where specific points of law are discussed to see if any of them have overruling language in the opinion text. One of these portions is likely to mention a rule or test that a court has adopted as law, even if this is not explicitly mentioned in the headnote that the new rule or test is replacing or overruling an older one. When the best/highly relevant portion in the opinion text that contains the overruling language is identified, the SME is to return to the headnotes and look for one that states the newly adopted rule/test/law. This step may not be necessary in cases where the headnotes contain language explicitly indicating the overruling (e.g., where the explicit language in the headnote indicated the corresponding opinion portion). In these cases, the headnote might simply state the newly adopted rule without mentioning anything about the rule being new or overruling a prior rule.

Next, the SME searches for the corresponding rule or point of law that was overruled in the overruled case. The SME may scan the headnotes to look for language that is similar to the rule discussed and rejected in the text of the overruling case in order to use the headnote number link to automatically scroll down to the portion of the overruled case stating the relevant rule or point of law. However, this can be tricky and the language used might not always be a one-to-one match between the overruling case and the overruled case, so it may require more reading to find the highly relevant language in the overruled case. Also, in some instances the headnote number that explicitly indicates an overruling or a rule or point of law may not line up with the headnote number reference in the portion of the opinion text which discusses the overruled law due to headnotes often linking to the beginning of a discussion, but not the most highly relevant portion. That portion may be further down, even if that is in another portion associated with a different headnote.

After finding the most highly relevant portions of the overruling case and the overruling case, the SME annotates these portions. This text may come from either a headnote, the opinion text, or a footnote of either document. Sometimes both the headnote and the opinion text or footnote text will both be relevant, and thus may be annotated. After selecting the language for annotation, the SME may also indicate whether the text is “Highly Relevant” or merely “Relevant.” In other implementations, other rankings may be used. In these implementations, the following guidelines may apply: there should always be a Highly Relevant paragraph and/or headnote for each overruling case and overruled case. The explicitness of the overruling language (e.g., “overruled,” “abrogated,” etc.) is not the only factor in determining whether the text is “highly relevant”; such language is useful for identifying the highly relevant headnote or opinion portion, not for determining the relevance. Instead, the “highly relevant” portion is the “best” or most relevant language with respect to indicating an overruling of a point of law is taking place in the documents. This determination may be based on the perspective of a user using the legal research tool. “Relevant” text, in comparison, should indicate a second (or possibly a third, in rare circumstances) opinion paragraph in the vicinity of a “highly relevant” but perhaps not very explicit portion that has some relevant language that assists in identification or understanding of the highly relevant portion. This is more likely in situations where a SME identifies multiple portions as relevant and chooses between them to ultimately identify one as highly relevant and the remaining portions as relevant. The SME may be instructed not to continue searching for additional “relevant” portions if the language of the “highly relevant” portion is sufficiently clear. In these examples, it is expected that the SME will identify at least an opinion portion or footnote for each document, and that sometimes a headnote may also be identified, but with less frequency due to the nature of headnotes.

FIGS. 3A-C depict examples of a GUI 300 of a legal research tool that is configured to identify overruled in part content based on citationally related content according to one or more aspects. In some implementations, the GUI 300 may be generated and/or displayed by the computing device 102 of FIG. 1.

FIG. 3A depicts an example of the GUI 300 at a first time. At the first time, the GUI 300 may include multiple panes, such as a search pane 302, a title pane 304, a navigation pane 306, and a document pane 308. In other implementations, fewer or more panes than shown in FIG. 3A may be included in the GUI 300. The search pane 302 may include a search bar 310 which, when selected by a user, may enable the user to type in or otherwise provide the terms, citations, questions, or the like for which the user would like to perform legal research. For example, the user may type in a name of a court case, the name of a court reporter, the name of a point of law, or the like, to begin a legal search. The title pane 304 may include a title and other information related to a most-recently searched for document. For example, in the example of FIG. 3A, the user has searched for the court case “Greenacre v. Whiteacre”, and the title pane includes the name of the court case, the court that decided the case (e.g., the jurisdiction), the date of the case, the name, volume, and page number of the court case in a court reporter, and an approximate length of the court case. This information is illustrative, and for other types of documents, other information may be displayed. Additionally, the title pane 304 may include a visual indicator 312 that indicates a status of the case with respect to the validity of the points of law within. For example, the visual indicator 312 may be a red striped flag that indicates that the document indicated by the title pane 304 has been overruled in part. Other examples of visual indicators include a solid red flag that indicates a case has been fully overruled, or a green flag (or no symbol) that indicates that a case is currently good law. Other types of visual indicators, such as text, graphics, highlighting, and the like, are possible to convey the status of the searched-for document to the user. The title pane 304 may also include a selectable indicator 314 that causes the GUI 300 to display, in the case of a document that is overruled in part, the most relevant portion of the current document and, optionally, the most relevant portion of the overruling document. For example, the selectable indicator 314 may include a navigation bar, an arrow, a button, or the like, and the type of selectable indicator may be related to the type of status indicated by the visual indicator 312. The navigation pane 306 may include one or more identifiers of sections of the document, similar to a table of contents in a book. A visual indication 316, such as highlighting or a bounding box as non-limiting examples, may indicate which section is currently being displayed in the document pane 308. Selection of a different section identifier may cause the document pane 308 to automatically scroll to the section of the document that corresponds to the selected section identifier. The document pane 308 includes a current portion of the document that was retrieved using the search bar 310. In the example of FIG. 3A, the document pane 308 is displaying the synopsis of the Greenacre v. Whiteacre court case. The document pane 308 may also include a scroll bar or other element to enable the user to scroll through sections of the document displayed in the document pane 308.

As described above, a legal case that is overruled in part may have at least one point of law that is overruled, but still includes one or more points of law that can be relied upon. In this example, the visual indicator 312 being the striped flag indicates, to the user, that Greenacre v. Whiteacre is overruled in part, instead of fully overruled, using the ML and AI classifiers described above with reference to FIGS. 1-2. In order to avoid having to read the entirety of Greenacre v. Whiteacre and the overruling case, the user may select the selectable indicator 314 to be navigated directly to the language of the case that discusses the point of law that has been overruled.

FIG. 3B depicts an example of the GUI 300 at a second time after selection of the selectable indicator 314 in FIG. 3A. As shown in FIG. 3B, the text shown in the document pane 308 has been automatically scrolled to a passage (e.g., a paragraph in the opinion, a sentence in the opinion, or a footnote) that discusses the point of law being overruled. As the document pane 308 is now displaying part of the opinion, the visual indication 316 in the navigation pane now identifies the opinion as the selected section identifier. In some implementations, the overruled passage is visually indicated in the document pane 308 by visual indication 320. Visual indication 320 may include highlighting, a change in text color or font, or some other manner of indicating a particular portion of the text from a remainder of the text of the Greenacre v. Whiteacre case. Stated another way, selection of the selectable indicator 314 may enable the user to jump directly to the overruled issue in the case, where the relevant overruled language is highlighted or otherwise visually indicated for them, thereby avoiding the need for the user to perform time-consuming manual review of the retrieved overruled document. Additionally, the visual indication 320 may include another selectable indicator (e.g., another striped red flag), and selection of this additional selectable indicator (or the selectable indicator 314 in other implementations), may cause the GUI 300 to display a portion of the overruling case that caused the visual indicator 312 to be displayed.

FIG. 3C depicts an example of the GUI 300 at a third time after selection of the additional selectable indicator in FIG. 3B. As shown in FIG. 3C, the document pane 308 now includes a window 322 that includes the name, identifying information, and most relevant passage from a court case that overrules in part the case displayed in the document pane 308. In the example of FIG. 3C, the window 322 includes an indication that Brownacre v. Wilson has overruled in part Greenacre v. Whiteacre, as well as the citation information for Brownacre v. Wilson and the overruling passage (e.g., paragraph, sentence, footnote, etc.) from Brownacre v. Wilson. The overruling passage may be provided such that it is a pinpoint link that can be selected by the user to jump directly to that section in the overruling case, thereby avoiding the need for the user to perform time-consuming manual review of the retrieved overruling document.

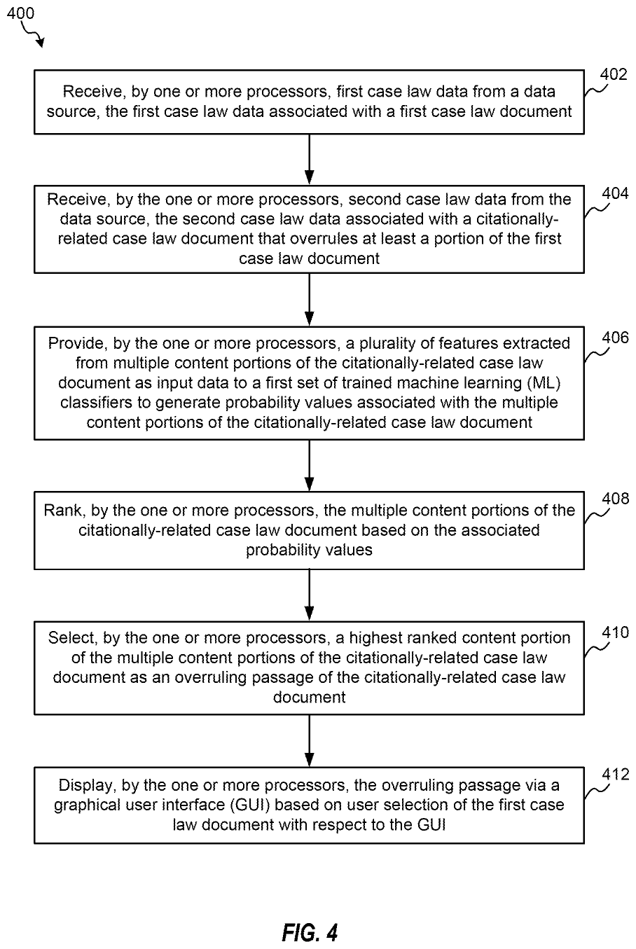

FIG. 4 is a flow diagram of a method 400 for identifying overruled in part content based on citationally related content according to one or more aspects. In some implementations, the operations of the method 400 may be stored as instructions that, when executed by one or more processors (e.g., the one or more processors of a computing device or a server), cause the one or more processors to perform the operations of the method 400. In some implementations, these instructions may be stored on a non-transitory computer-readable storage device or a non-transitory computer-readable storage medium. In some implementations, the method 400 may be performed by the system 100 of FIG. 1 (e.g., by the computing device 102), which may include prediction models 200 of FIG. 2 or be configured to display the GUI 300 of FIG. 3.

The method 400 includes receiving, by one or more processors, first case law data from a data source, at 402. The first case law data is associated with a first case law document. For example, the first case law data may include or correspond to the first case law data 170 of FIG. 1. The method 400 includes receiving, by the one or more processors, second case law data from the data source, at 404. The second case law data is associated with a citationally-related case law document that overrules at least a portion of the first case law document. For example, the second case law data may include or correspond to the second case law data 172 of FIG. 1.

The method 400 includes providing, by the one or more processors, a plurality of features extracted from multiple content portions of the citationally-related case law document as input data to a first set of trained ML classifiers to generate probability values associated with the multiple content portions of the citationally-related case law document, at 406. For example, the plurality of features may include or correspond to the extracted features 110 of FIG. 1, the first set of trained ML classifiers may include or correspond to a first set of the ML classifiers 119 of FIG. 1, the multiple content portions may include or correspond to the content portions 112 of FIG. 1, and the probability values may include or correspond to the probability values 114 of FIG. 1. In some implementations, the probability values associated with the multiple content portions of the citationally-related case law document indicate a probability that a corresponding content portion is relevant to overruling at least the portion of the first case law document.

The method 400 includes ranking, by the one or more processors, the multiple content portions of the citationally-related case law document based on the associated probability values, at 408. For example, the content portions 112 that are extracted from the first case law data 170 may be ranked based on corresponding ones of the probability values 114. The method 400 includes selecting, by the one or more processors, a highest ranked content portion of the multiple content portions of the citationally-related case law document as an overruling pas sage of the citationally-related case law document, at 410. For example, the overruling passage may include or correspond to the overruling passage 116 of FIG. 1. The method 400 further includes, at 412, displaying, by the one or more processors, the overruling passage via a GUI based on user selection of the first case law document with respect to the GUI. For example, the GUI may include or correspond to the GUI 300 of FIGS. 3A-C. In an aspect, the overruled passage may also be displayed via the GUI at 412 in addition to the overruling passage.

In some implementations, the plurality of features includes a set of heuristics-based features extracted from the multiple content portions of the citationally-related case law document and a set of statistics-based features extracted from the multiple content portions of the citationally-related case law document. For example, the set of heuristics-based features may include or correspond to heuristics-based features 232 of FIG. 2 and the set of statistics-based features may include or correspond to the statistics-based features 234 of FIG. 2. In some such implementations, the heuristics-based features may include one or more similarity features indicating a similarity between one or more particular headnotes and the multiple content portions of the citationally-related case law document, one or more distance features indicating a positional distance between one or more particular paragraphs and the multiple content portions of the citationally-related case law document, one or more binary features indicating whether the multiple content portions of the citationally-related case law document include particular text, or a combination thereof. In some such implementations, the one or more particular headnotes may include the particular text, the one or more particular paragraphs may include the particular text, and the particular text may include one or more overruling terms or language patterns, a citation to the first case law document, a pincite to the first case law document, or a combination thereof. Additionally or alternatively, the statistics-based features may include TF-IDF vectors generated based on the multiple content portions of the citationally-related case law document.

In some implementations, the first set of trained ML classifiers include an ensemble of a first ML classifier and a second ML classifier. The first ML classifier is configured to receive the heuristics-based features as the input data and to generate a first set of probability values associated with the multiple content portions of the citationally-related case law document, and the second ML classifier is configured to receive the statistics-based features as the input data and to generate a second set of probability values associated with the multiple content portions of the citationally-related case law document. For example, the first ML classifier may include or correspond to the FNN classifier 214 of FIG. 2, and the second ML classifier may include or correspond to the XGBoost classifier 216 of FIG. 2. In some such implementations, generating the probability values associated with the multiple content portions of the citationally-related case law document includes, for each content portion of the multiple content portions of the citationally-related case law document, combining a value from the first set of probability values that is associated with the content portion with a value from the second set of probability values that is associated with the content portion.

In some implementations, the method 400 further includes selecting a highest ranked subset of the multiple content portions of the citationally-related case law document, providing a second plurality of features extracted from the highest ranked subset as input data to a second set of trained ML classifiers to generate probability values associated with multiple headnotes of the first case law document, and ranking, by the one or more processors, the multiple headnotes of the first case law document based on the associated probability values. For example, the highest ranked subset of the multiple content portions of the citationally-related case law document may include the highest ranked subset 238 of FIG. 2, and the second set of trained ML classifiers may include or correspond to the second set of ML classifiers 220 of FIG. 2. In some such implementations, the second plurality of features include one or more similarity features indicating a similarity between the highest ranked subset and the multiple headnotes of the first case law document, as describe above with reference to FIG. 2. Additionally or alternatively, the second set of trained ML classifiers may include a linear ML classifier.

In some such implementations, the method 400 also includes providing a third plurality of features extracted from multiple content portions of the first case law document and a highest ranked headnote of the multiple headnotes as input data to a third set of trained ML classifiers to generate probability values associated with the multiple content portions of the first case law document, ranking the multiple content portions of the first case law document based on the associated probability values, selecting a highest ranked content portion of the multiple content portions of the first case law document as an overruled-in-part passage of the first case law document, and displaying the overruled-in-part passage via the GUI. For example, the third set of trained ML classifiers may include or correspond to the third set of ML classifiers 224 of FIG. 2, the overruled-in-part passage may include or correspond to the overruled passage 118 of FIG. 1 or the highest ranked content portion 242 of FIG. 2, and the GUI may include or correspond to the GUI 300 of FIG. 3. In some such implementations, the third set of ML classifiers includes a second FNN classifier. Additionally or alternatively, displaying the overruled-in-part passage may include highlighting or visually indicating the overruled-in-part passage, automatically scrolling through the first case law document to a beginning of the overruled-in-part passage, or both, as described with reference to FIGS. 3B and 3C. Additionally or alternatively, the third plurality of features may include one or more similarity features indicating a similarity between the highest ranked headnote and the multiple content portions of the first case law document, one or more distance features indicating a positional distance between one or more paragraphs linked to the highest ranked headnote and the multiple content portions of the first case law document, one or more binary features indicating whether the multiple content portions of the first case law document include holding text or language patterns, or a combination thereof, as described above with reference to FIG. 2.

Components, the functional blocks, and the modules described herein with respect to FIGS. 1-4) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for identifying overruled in part content based on citationally related content, the method comprising:
receiving, by one or more processors, first case law data from a data source, the first case law data associated with a first case law document;
receiving, by the one or more processors, second case law data from the data source, the second case law data associated with a citationally-related case law document that overrules at least a portion of the first case law document;
providing, by the one or more processors, a plurality of features extracted from multiple content portions of the citationally-related case law document as input data to a first set of trained machine learning (ML) classifiers to generate probability values associated with the multiple content portions of the citationally-related case law document;
ranking, by the one or more processors, the multiple content portions of the citationally-related case law document based on the associated probability values;
selecting, by the one or more processors, a highest ranked content portion of the multiple content portions of the citationally-related case law document as an overruling passage of the citationally-related case law document; and
displaying, by the one or more processors, the overruling passage via a graphical user interface (GUI) based on user selection of the first case law document with respect to the GUI.

2. The method of claim 1, wherein the probability values associated with the multiple content portions of the citationally-related case law document indicate a probability that a corresponding content portion is relevant to overruling at least the portion of the first case law document.

3. The method of claim 1, wherein the plurality of features includes a set of heuristics-based features extracted from the multiple content portions of the citationally-related case law document and a set of statistics-based features extracted from the multiple content portions of the citationally-related case law document.

4. The method of claim 3, wherein the heuristics-based features include one or more similarity features indicating a similarity between one or more particular headnotes and the multiple content portions of the citationally-related case law document, one or more distance features indicating a positional distance between one or more particular paragraphs and the multiple content portions of the citationally-related case law document, one or more binary features indicating whether the multiple content portions of the citationally-related case law document include particular text, or a combination thereof.

5. The method of claim 4, wherein the one or more particular headnotes include the particular text, wherein the one or more particular paragraphs include the particular text, and wherein the particular text includes one or more overruling terms or language patterns, a citation to the first case law document, a pincite to the first case law document, or a combination thereof.

6. The method of claim 3, wherein the statistics-based features include term frequency-inverse document frequency (TF-IDF) vectors generated based on the multiple content portions of the citationally-related case law document.

7. The method of claim 3, wherein the first set of trained ML classifiers comprises an ensemble of a first ML classifier and a second ML classifier, wherein the first ML classifier is configured to receive the heuristics-based features as the input data and to generate a first set of probability values associated with the multiple content portions of the citationally-related case law document, and wherein the second ML classifier is configured to receive the statistics-based features as the input data and to generate a second set of probability values associated with the multiple content portions of the citationally-related case law document.

8. The method of claim 7, wherein the first ML classifier comprises a feed forward neural network (FNN) classifier, and wherein the second ML classifier comprises an extreme gradient boosting (XGBoost) classifier.

9. The method of claim 7, wherein generating the probability values associated with the multiple content portions of the citationally-related case law document includes, for each content portion of the multiple content portions of the citationally-related case law document, combining a value from the first set of probability values that is associated with the content portion with a value from the second set of probability values that is associated with the content portion.

10. A system for identifying overruled in part content based on citationally related content, the system comprising:
a memory; and
one or more processors communicatively coupled to the memory, the one or more processors configured to:
receive first case law data from a data source, the first case law data associated with a first case law document;
receive second case law data from the data source, the second case law data associated with a citationally-related case law document that overrules at least a portion of the first case law document;
provide a plurality of features extracted from multiple content portions of the citationally-related case law document as input data to a first set of trained machine learning (ML) classifiers to generate probability values associated with the multiple content portions of the citationally-related case law document;
rank the multiple content portions of the citationally-related case law document based on the associated probability values;
select a highest ranked content portion of the multiple content portions of the citationally-related case law document as an overruling passage of the citationally-related case law document; and
display the overruling passage via a graphical user interface (GUI) based on user selection of the first case law document with respect to the GUI.

11. The system of claim 10, wherein the one or more processors are further configured to:
select, by the one or more processors, a highest ranked subset of the multiple content portions of the citationally-related case law document;
provide, by the one or more processors, a second plurality of features extracted from the highest ranked subset as input data to a second set of trained ML classifiers to generate probability values associated with multiple headnotes of the first case law document; and
rank, by the one or more processors, the multiple headnotes of the first case law document based on the associated probability values.

12. The system of claim 11, wherein the second plurality of features include one or more similarity features indicating a similarity between the highest ranked subset and the multiple headnotes of the first case law document.

13. The system of claim 11, wherein the second set of trained ML classifiers comprises a linear ML classifier.

14. The system of claim 11, wherein the one or more processors are further configured to:
provide, by the one or more processors, a third plurality of features extracted from multiple content portions of the first case law document and a highest ranked headnote of the multiple headnotes as input data to a third set of trained ML classifiers to generate probability values associated with the multiple content portions of the first case law document;
rank, by the one or more processors, the multiple content portions of the first case law document based on the associated probability values;
select, by the one or more processors, a highest ranked content portion of the multiple content portions of the first case law document as an overruled-in-part passage of the first case law document; and
display, by the one or more processors, the overruled-in-part passage via the GUI.

15. The system of claim 14, wherein displaying the overruled-in-part passage includes highlighting or visually indicating the overruled-in-part passage, automatically scrolling through the first case law document to a beginning of the overruled-in-part passage, or both.

16. The system of claim 14, wherein the third plurality of features includes one or more similarity features indicating a similarity between the highest ranked headnote and the multiple content portions of the first case law document, one or more distance features indicating a positional distance between one or more paragraphs linked to the highest ranked headnote and the multiple content portions of the first case law document, one or more binary features indicating whether the multiple content portions of the first case law document include holding text or language patterns, or a combination thereof.

17. The system of claim 14, wherein the third set of ML classifiers comprises a second feed forward neural network (FNN) classifier.

18. The system of claim 14, wherein the overruled-in-part passage comprises a sentence, a paragraph, or a footnote of the citationally-related case law document.

19. A non-transitory computer-readable storage device comprising instructions that, when executed by one or more processors, cause the one or more processors to perform operations for identifying overruled in part content based on citationally related content, the operations comprising:
receiving first case law data from a data source, the first case law data associated with a first case law document;
receiving second case law data from the data source, the second case law data associated with a citationally-related case law document that overrules at least a portion of the first case law document;
providing a plurality of features extracted from multiple content portions of the citationally-related case law document as input data to a first set of trained machine learning (ML) classifiers to generate probability values associated with the multiple content portions of the citationally-related case law document;
ranking the multiple content portions of the citationally-related case law document based on the associated probability values;
selecting a highest ranked content portion of the multiple content portions of the citationally-related case law document as an overruling passage of the citationally-related case law document; and
displaying the overruling passage via a graphical user interface (GUI) based on user selection of the first case law document with respect to the GUI.

20. The non-transitory computer-readable storage device of claim 19, wherein the overruling passage comprises a sentence, a paragraph, or a footnote of the citationally-related case law document.
